(19) United States
(12) Patent Application Publication
(10) Pub. No.: US 2024/0394637 A1
(43) Pub. Date: Nov. 28, 2024

(54) KNOWLEDGE GRAPH CONSTRUCTION SYSTEM AND KNOWLEDGE GRAPH CONSTRUCTION METHOD

(71) Applicants: Digiwin Software Co., Ltd, Shanghai (CN); DATA SYSTEMS CONSULTING CO., LTD., New Taipei City (TW)

(72) Inventors: Xu Jin, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/351,508

(22) Filed: Jul. 13, 2023

(30) Foreign Application Priority Data
May 22, 2023 (CN) 202310575473.3

(51) Int. Cl. G06Q 10/0637; G06Q 10/0639; G06Q 10/067

(52) U.S. Cl. CPC G06Q 10/06375; G06Q 10/06395; G06Q 10/067

(57) ABSTRACT

A knowledge graph construction system and a knowledge graph construction method are provided. The knowledge graph construction system includes a storage device and a processor. The processor executes multiple modules in the storage device. The computing module respectively executes an index computation operation according to multi-level historical data in the enterprise system to generate multi-level index data. The classification and parsing module respectively executes a classification and parsing operation on the multi-level index data to generate a multi-level graph. The integration module sequentially integrates an i-level graph and a consecutive next-level graph in the multi-level graph according to a rule until graphs at all levels in the multi-level graph are integrated to generate an output graph, so that the enterprise system executes a prediction operation according to the output graph to improve accuracy.

### CROSS-REFERENCE TO RELATED APPLICATION

This application claims the priority benefit of China application serial no. 202310575473.3, filed on May 22, 2023. The entirety of the above-mentioned patent application is hereby incorporated by reference herein and made a part of this specification.

### BACKGROUND

### Technical Field

The disclosure relates to a knowledge graph system, and more particularly, to a knowledge graph construction system and a knowledge graph construction method applied in the manufacturing industry.

### Description of Related Art

Generally, knowledge graphs can be applied in various application systems such as retrieval systems, question-answering systems, and recommendation systems.

The knowledge graph can present different types of information as structured data composed of multiple nodes and connection relationships to form a structured semantic database. The knowledge graphs can be applied in various application systems such as retrieval systems, question-answering systems, and recommendation systems. For example, an enterprise system in the manufacturing industry can utilize a knowledge graph to obtain a recommended list of suppliers, allowing enterprise users to choose suitable suppliers. However, based on the current knowledge graph, the enterprise system cannot generate recommendation results that align with specific requirements (such as supplier performance predictions regarding on-time delivery or other operations).

### SUMMARY

The disclosure relates to a knowledge graph construction system applied in the manufacturing industry, which is capable of constructing a comprehensive knowledge graph to improve the accuracy of predictive operations based on the knowledge graph.

According to the embodiment of the disclosure, the knowledge graph construction system of the disclosure includes a storage device and a processor. The storage device stores multiple modules. The storage device accesses an enterprise system. The processor is coupled to the storage device. The processor executes multiple modules. The modules include a computing module, a classification and parsing module, and an integration module. The computing module respectively executes an index computation operation according to multi-level historical data in the enterprise system to generate multi-level index data. The classification and parsing module respectively executes a classification and parsing operation on the multi-level index data to generate a multi-level graph. The integration module sequentially integrates an i-level graph and a consecutive next-level graph in the multi-level graph according to a rule until graphs at all levels in the multi-level graph are integrated to generate an output graph, so that the enterprise system executes a prediction operation according to the output graph. i is a positive integer.

According to the embodiment of the disclosure, the knowledge graph construction method of the disclosure is described below. Multiple modules are stored and an enterprise system is accessed through a storage device. The modules are executed through a processor. The modules include a computing module, a classification and parsing module, and an integration module. Executing multiple modules includes the following process. An index computation operation is respectively executed through the computing module according to multi-level historical data in the enterprise system to generate multi-level index data. A classification and parsing operation is respectively executed on the multi-level index data through the classification and parsing module to generate a multi-level graph. An i-level graph and a consecutive next-level graph in the multi-level graph are sequentially integrated through the integration module according to a rule until graphs at all levels in the multi-level graph are integrated to generate an output graph, so that the enterprise system executes a prediction operation according to the output graph. i is a positive integer.

Based on the above, the knowledge graph construction system and the knowledge graph construction method of the disclosure utilize the classification and parsing module to analyze the computational logic of each level of historical data and generate corresponding knowledge graphs at all levels. This enables the construction of multiple related graphs. The multi-level graph is sequentially integrated according to the rule through the integration module, which may automatically grow and optimize the knowledge graph to generate an output graph. In this way, when the enterprise system executes the prediction operation based on the output graph, the prediction of the prediction operation or the accuracy of the recommendation result may be improved.

In order to make the above-mentioned features and advantages of the disclosure comprehensible, embodiments accompanied with drawings are described in detail below.

### BRIEF DESCRIPTION OF THE DRAWINGS

FIG. 1 is a circuit block diagram of a knowledge graph construction system according to an embodiment of the disclosure.

FIG. 2 is a flowchart of a knowledge graph construction method according to an embodiment of the disclosure.

FIG. 3 is an operation schematic view of a knowledge graph construction system according to an embodiment of the disclosure.

FIG. 4 is a schematic view of the output graph in the embodiment of FIG. 3 of the disclosure.

### DESCRIPTION OF THE EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

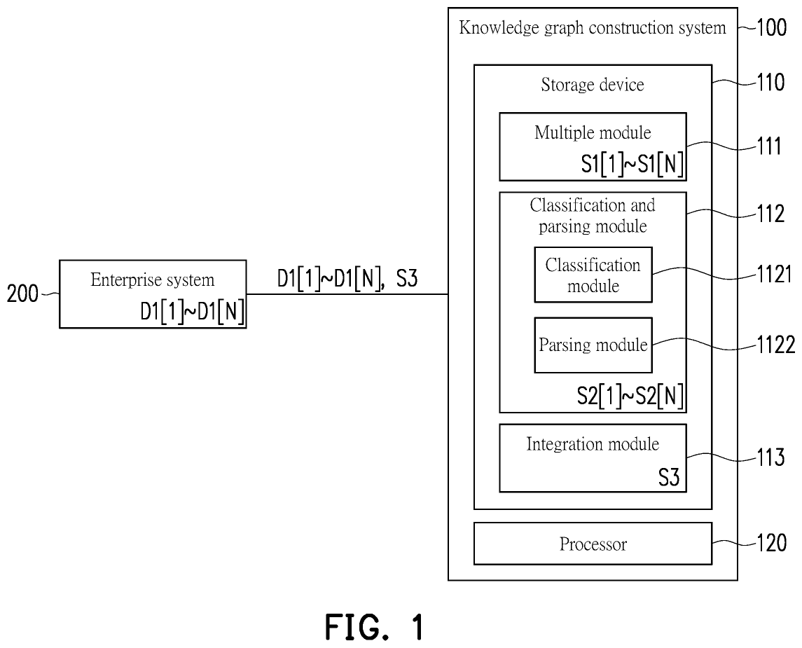

FIG. 1 is a circuit block diagram of a knowledge graph construction system according to an embodiment of the disclosure. Referring to FIG. 1, a knowledge graph construction system 100 may be applied to the manufacturing industry to construct a knowledge graph (e.g., output graph S3) based on application data (e.g., multi-level historical data D1[1]˜D1[N]) specific to the manufacturing industry. The knowledge graph construction system 100 is coupled to an enterprise system 200.

In this embodiment, a user may operate the knowledge graph construction system 100 by calling an application programming interface (API) through an electronic device, and then obtain the output graph S3 through the knowledge graph construction system 100. The user may also operate the enterprise system 200 through the electronic device by calling the API, and then execute various business services through the enterprise system 200. The business services may include, for example, the execution of a prediction operation by the enterprise system 200 based on the output graph S3 in order to generate a recommendation result. The enterprise system 200 may be, for example, an enterprise resource planning (ERP) system. The electronic device may be, for example, a mobile phone, a tablet computer, a laptop, and a desktop computer.

In this embodiment, the knowledge graph construction system 100 may be deployed in a cloud, allowing users to connect through the enterprise system 200 and execute various business service functions via different APIs that are set up in the knowledge graph construction system 100, such as the relevant functions of an ERP system. The knowledge graph construction system 100 may be, for example, a software as a service (SaaS) server, so as to execute a corresponding SaaS application through an API. In some embodiments, the knowledge graph construction system 100 may be deployed within the enterprise's on-premises environment, allowing users to connect the knowledge graph construction system 100 with other systems deployed in the cloud through the enterprise system 200. This enables the input/output of data and the execution of corresponding SaaS application through an API. In some embodiments, the knowledge graph construction system 100 may be integrated with the enterprise system 200.

In this embodiment, the knowledge graph construction system 100 may include a storage device 110 and a processor 120. The storage device 110 may store multiple modules 111˜113. These modules may include a computing module 111, a classification and parsing module 112, and an integration module 113. In this embodiment, the storage device 110 may access multi-level historical data D1[1]˜D1[N] in the enterprise system 200. N is a positive integer and may indicate the level (or number of groups) of historical data D1.

In this embodiment, the multi-level historical data D1[1]˜D1[N] may be, for example, data related to purchasing task previously performed by the enterprise system 200. The multi-level historical data D1[1]˜D1[N] includes first-level historical data D1 [1], second-level historical data D1[2] . . . , and N-level historical data D1[N] with the same attribute (e.g., purchasing task). Different levels may indicate different years, different directors, or other variant attributes.

In this embodiment, the storage device 110 may also store various algorithms, computing software, and other similar items related to each of the modules 111˜113 for implementing the relevant algorithms, programs, and data for index calculation, classification, parsing, integration, and various computations of the disclosure. The storage device 110 may be, for example, dynamic random access memory (DRAM), flash memory, non-volatile random access memory (NVRAM), or a combination of the foregoing.

In this embodiment, the processor 120 is coupled to the storage device 110. The processor 120 may access the storage device 110, and may execute data in the storage device 110, various modules 111˜113, and data from the enterprise system 200 (e.g., multi-level historical data D1). In this embodiment, the processor 120 may be, for example, a signal converter, a field programmable gate array (FPGA), a central processing unit (CPU), other programmable general purpose or special-purpose microprocessor, a digital signal processor (DSP), a programmable controller, an application specific integrated circuits (ASIC), a programmable logic device (PLD), other similar devices, or a combination of the foregoing, which may load and execute computer program-related firmware or software to implement index calculation, classification, analysis, integration, and various calculation functions.

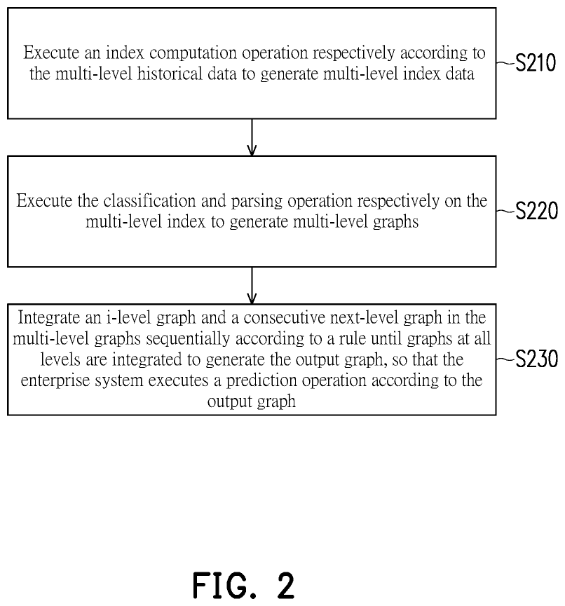

FIG. 2 is a flowchart of a knowledge graph construction method according to an embodiment of the disclosure. Referring to FIG. 1 and FIG. 2, the knowledge graph construction system 100 may execute steps S210˜S230. The order of the steps S210˜S230 is only an example for illustration, and is not limited thereto.

In step S210, the processor 120 executes the computing module 111, so that the computing module 111 respectively executes an index computation operation according to the multi-level historical data D1[1]˜D1[N] in the enterprise system 200 to generate multi-level index data S1[1]˜S1[N]. In this embodiment, the multi-level index data S1[1]˜S1[N] corresponds to the multi-level historical data D1[1]˜D1[N], and may include first-level index data S1[1], second-level index data S1[2], . . . , and N-level index data S2[N].

That is, the computing module 111 utilizes a correlation table to calculate an association relationship of the first-level historical data D1[1] to generate relevant indexes required by a classification and parsing operation (i.e., the first-level index data S1[1]) and calculate an association relationship of the second-level historical data D1[2] to generate corresponding relevant indexes (i.e., the second-level index data S1[2]), and so on. In this embodiment, the correlation table may, for example, include purchase order forms, goods receipt forms, and vendor basic data forms in the enterprise system 200.

In step S220, the processor 120 executes the classification and parsing module 112, so that the classification and parsing module 112 respectively executes the classification and parsing operation on the multi-level index data S1[1]˜S1[N] to generate multi-level graphs S2[1]˜S2[N]. In this embodiment, the multi-level graphs S2[1]˜S2[N] corresponds to the multi-level historical data D1[1]˜D1[N] and the multi-level index data S1[1]˜S1[N] respectively, which may also include a first-level graph S2[1], a second-level graph S2[2] . . . , an i-level graph S2[i] . . . , and the N-level index data S2[N]. i is a positive integer less than or equal to N.

That is, the classification and parsing module 112 classifies the first-level index data S1[1] and converts a classification result of the first-level index data S1[1] into structured data to generate the first-level graph S2[1]. The classification and parsing module 112 classifies the i-level index data S1[i] and converts a classification result of the i-level index data S1[i] into structured data to generate the i-level graph S2[i], and so on.

In step S230, the processor 120 executes the integration module 113, so that an i-level graph and a consecutive next-level graph (e.g., an i+1-level graph) in the multi-level graphs S2[1]˜S2[N] are sequentially integrated through the integration module 113 according to a rule until graphs at all levels in the multi-level graphs S2[1]˜S2[N] are integrated to generate the output graph S3, so that the enterprise system 200 executes a prediction operation according to the output graph S3. In this embodiment, the output graph S3 may be, for example, a single knowledge graph formed by integrating the multi-level graphs S2[1]˜S2[N].

In detail, the integration module 113 integrates the first-level graph S2[1] and the consecutive next-level graph S2[2] (i.e., a 1+1-level graph) according to the rule to generate a new graph (i.e., a graph to be integrated). Next, the integration module 113 integrates the graph to be integrated and the consecutive next-level graph S2[3] (i.e., 2+1-level graph) according to the rule to update the graph to be integrated, and so on. The integration module 113 integrates the current graph to be integrated and the last N-level graph S2[N] according to the rule to generate the output graph S3. That is, the integration module 113 integrates the multi-level graphs S2[1]˜S2[N] into a single output graph S3 by using integration-related rules, so as to reduce the redundancy and complexity of the knowledge graph while expanding the knowledge graph.

In this embodiment, the enterprise system 200 may call a recommendation module through an API, so that the recommendation module may provide prediction or recommendation result according to the output graph S3 and a target requirement (e.g., delivery rate). The prediction or recommendation result may be, for example, prediction data related to the purchasing task, such as the successful delivery rate of the first supplier, the late delivery rate of the second supplier, or a combination of the foregoing.

It is worth mentioning here that the computing module 111 may automatically construct the multi-level graphs S2[1]˜S2[N] with the same attribute (e.g., purchasing task-related) by generating the multi-level index data S1[1]˜S1[N] corresponding to the multi-level historical data D1[1]˜D1[N] and classifying and parsing the calculation logic of the index data S1[1]˜S1[N] at all levels through the classification and parsing module 112 to generate corresponding graphs S2[1]˜S2[N] at all levels. In addition, by sequentially integrating the multi-level graphs S2[1]˜S2[N] through the integration module 113 according to the rule, the knowledge graph may be automatically expanded while reducing the redundancy and complexity of the knowledge graph at the same time, and the output graph S3 may be output accordingly. Thus, the enterprise system 200 may execute a prediction operation based on the output graph S3, so as to achieve a prediction or recommendation result with high accuracy.

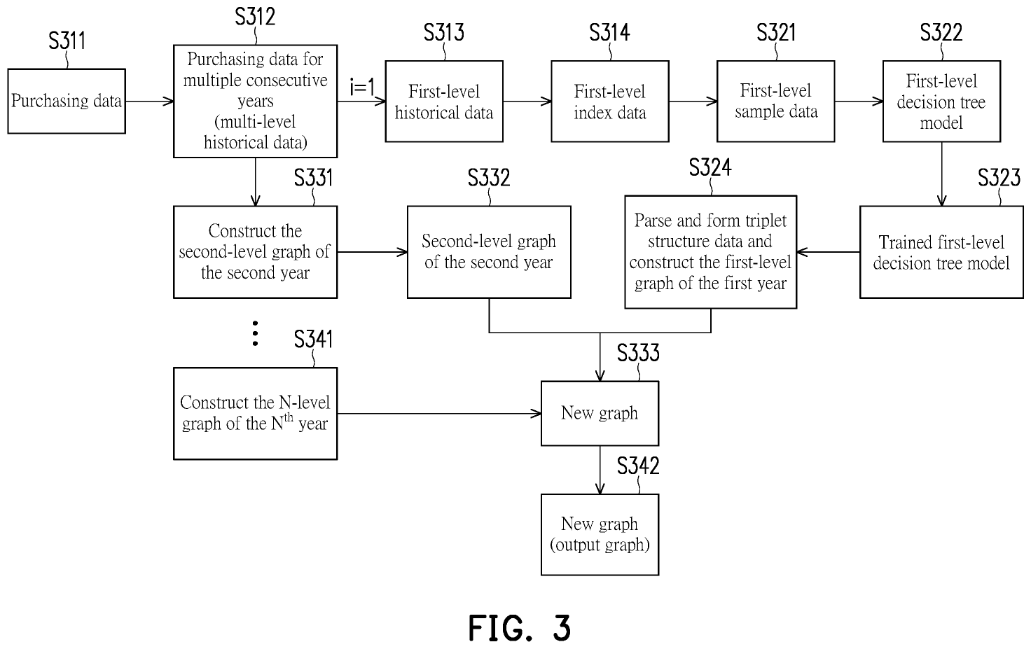

FIG. 3 is an operation schematic view of a knowledge graph construction system according to an embodiment of the disclosure. Referring to FIG. 1 and FIG. 3, the knowledge graph construction system 100 and the enterprise system 200 cooperate to implement the construction of a target knowledge graph (i.e., the output graph S3) by executing modules S311˜S342. In this embodiment, the classification and parsing module 112 may include a classification module 1121 and a parsing module 1122.

In module S311, the processor 120 executes the computing module 111, so that the computing module 111 accesses purchasing data in the enterprise system 200. In module S312, the processor 120 executes the computing module 111, so that the computing module 111 collects the purchasing data based on years to obtain the purchasing data for multiple consecutive years (i.e., multi-level historical data D1[1]˜D1[N]).

In this embodiment, the multi-level historical data D1[1]˜D1[N] include multiple work orders corresponding to multiple consecutive years. These work orders are related to the purchasing task, and may be purchasing data such as purchase order, procurement order, return order, or a combination of the foregoing. In detail, the first-level historical data D1[1] may be, for example, the purchasing data of the first year, the second-level historical data D1[2] may be, for example, the purchasing data of the second year, and the i-level historical data D1[i] It may be, for example, the purchasing data of the i^{th} year, and so on.

In modules S313˜S314, the processor 120 executes the computing module 111, so that the computing module 111 executes the index computation operation. In this embodiment, the index computation operation may be, for example, an ETL index computation operation, including operations such as extracting, transforming, and loading. Modules S313˜S314 may be, for example, implementation details of step S210.

Specifically, in module S313, the computing module 111 extracts the purchasing data from multiple years (i.e., multi-level historical data D1[1]˜D1[N]) to obtain the purchasing data for the i^{th} year (if i=1, then it corresponds to the first-level historical data D1[1]). In module S314, the computing module 111 calculates the association relationship between the purchasing data of the i^{th} year (if i=1, then it corresponds to the first-level historical data D1[1]) to generate the relevant index of the purchasing data of this year (if i=1, then it corresponds to the first-level index data S1[1]).

In detail, if i=1, the computing module 111 calculates the association relationship between the purchase order, the procurement order, and vendor basic data forms within the first-level historical data D1[1] and generates indexes (i.e., first-level index data S1[1]) related to this supplier accordingly. In this embodiment, the first-level index data S1[1] may include index data such as delivery time and delay time of orders, as well as delivery data related to the supplier, such as the number of orders, the number of successful deliveries in the past month, the number of returns in the past month, the average delivery time in the past month, and the number of special purchases in the past month.

In modules S321˜S323, the processor 120 executes the classification module 1121, so that the classification module 1121 executes the classification operation according to the data after the ETL index computation operation (i.e., the i-level index data S1[i]) and generates a multi-dimensional predictive model (e.g., i-level decision tree model). This predictive model may predict information related to the performance of the supplier. In this embodiment, the classification operation may include, for example, preprocessing operation, variance operation, and calculation operation using decision tree. Modules S321˜S323 may be, for example, the implementation details of step S220.

Specifically, in module S321, the classification module 1121 executes the preprocessing operation and the variance operation on the i-level index data (if i=1, then it corresponds to the first-level index data S1[1]) in the multi-level index data to generate i-level sample data (if i=1, then it corresponds to first-level sample data).

In detail, if i=1, the classification module 1121 executes the preprocessing operation such as eliminating contaminated data and filling missing data on the relevant index of the purchasing data in the first year (i.e., first-level index data S1[1]). Next, the classification module 1121 executes the variance operation to analyze the preprocessed first-level index data S1[1] to obtain sample array and sample labels of the purchasing data in the first year (i.e., the first-level sample data). In this embodiment, the first-level sample data may be, for example, various characteristic data of the purchasing data in the first year, such as probability of on-time delivery and delayed delivery probability per month.

In module S322, the classification module 1121 utilizes the decision tree to construct the i-level decision tree model in the multi-level decision tree model (if i=1, then it corresponds to the first-level decision tree model). In module S323, the classification module 1121 trains the i-level decision tree model according to the i-level sample data (if i=1, then it corresponds to the first-level sample data), so as to generate the trained i-level decision tree model (if i=1 1, then it corresponds to the first-level decision tree model).

In detail, if i=1, the classification module 1121 utilizes the decision tree algorithm to construct a first-level decision tree model to include multiple data nodes. The classification module 1121 selects the first-level sample data as a feature for model training. The classification module 1121 utilizes the feature to train the first-level decision tree model to evaluate and optimize the trained first-level decision tree model.

In module S324, the processor 120 executes the parsing module 1122, so that the parsing module 1122 executes the parsing operation on the trained model (i.e., the i-level decision tree model) to form triplet structure data and construct this structure data into the corresponding i-level graph S2[i] (if i=1, then it corresponds to the first-level graph S2[1] of the first year). That is, the parsing module 1122 converts the trained i-level decision tree model (if i=1, then it corresponds to the first-level decision tree model) into the triplet structure data to generate the i-level graph S2[i] (if i=1, then it corresponds to the first-level graph S2[1] of the first year). In this embodiment, the parsing operation may, for example, include operations such as analysis, disassembly, entity alignment, and conversion. Module S324 may be, for example, the implementation details of step S220.

In this embodiment, the i-level graph S2[i] may include the triplet structure data. The triplet structure data may include one or more factor nodes, one or more condition nodes, and one or more conclusion nodes. In this embodiment, the condition node may indicate a judging condition on a route from a root node to an end node (i.e., a leaf node) in the i-level decision tree model. The factor node may indicate all feature sets in the judging condition and may be used as the root node. The conclusion node may indicate a decision result in the judging condition and may be used as a leaf node.

In module S331, the processor 120 executes modules S313˜S324 according to the purchasing data of the next year (if i=1, then it corresponds to the second-level historical data D1[2]) to construct the i+1-level graph S2[i+1] (if i=1, then it corresponds to the second-level graph S2[2] of the second year). In this embodiment, the operation of module S325 may refer to the operation of modules S313˜S324 and be by analogy (i.e., replacing i=1 with i=2).

It should be noted that since the computing module 111 divides the purchasing data into multiple groups of data according to the year (i.e., multi-level historical data D1[1] ˜D1[N]), the classification module 1121 and the parsing module 1122 may construct a corresponding decision tree model according to the data D1[1]˜D1[N] of each year and construct the corresponding graphs S2[1]˜S2[N] accordingly.

In modules S332˜S333, the processor 120 executes the integration module 113 to enable the integration module 113 to integrate the i-level graph S2[i] and the i+1-level graph S2[i+1] according to the rule (if i=1, then they correspond to the first-level graph S2[1] and the second-level graph S2 [2]) to generate a new graph.

In this embodiment, since any level of graph S2[i] includes at least one factor node, at least one condition node, and at least one conclusion node, in modules S332˜S333, the integration module 113 compares multiple nodes with the same attribute (e.g., factor node and factor node, and/or condition node and condition node) of the graphs S2[i] and S2[i] at different levels, respectively, to generate a comparison result. The integration module 113 judges whether the comparison result conforms to the rule and integrates the graph S2[i] and S2[i+1] accordingly. That is, in response to the first node (e.g., factor node) of the i-level graph S2[i] and the second node (e.g., factor node) of the i+1-level graph S2[i+1] satisfying the rule, the integration module 113 integrates the i-level graph S2[i] and the i+1-level graph S2[i+1] (if i=1, then they correspond to the first graph S2[1] and the second graph S2[2]) to generate a new graph.

In this embodiment, the rule may include at least one of matching relationships between the factor nodes, the condition nodes, and the conclusion nodes and the i-level graph S2[i] and the i+1-level graph S2[i+1], respectively. For example, the rule may include the following scenarios.

A first scenario includes, if i=1, the factor nodes of the two graphs S2[1] and S2[2] are consistent. Condition factors corresponding to all factor nodes are only different in one condition factor, and the intersection of other condition factors is an empty set. An absolute value of the difference of the probability of on-time delivery respectively indicated by the conclusion nodes of the two graphs S2[1] and S2[2] is less than a threshold value of 0.25, and the indicated probabilities are greater than 0.5 at the same time, or less than or equal to 0.5 at the same time.

A second scenario includes, if i=1, the factor nodes of the two graphs S2[1] and S2[2] are consistent. The probability of on-time delivery indicated by the conclusion node of the graph S2[1] is greater than the probability of on-time delivery indicated by the conclusion node of another graph S2[2]. The condition nodes corresponding to only one of all the factor nodes in the graph S2[1] are a superset of the condition nodes corresponding to another graph S2[21]. The condition nodes corresponding to other factor nodes of the graph S2[1] are a subset of the condition nodes corresponding to another graph S2[2]. An absolute value of the difference of the probability respectively indicated by the conclusion nodes of the two graphs S2[1] and S2[2] is greater than a threshold value of 0.02, and the indicated probabilities are greater than 0.5 at the same time, or less than or equal to 0.5 at the same time.

A third scenario includes, if i=1, the factor nodes of the graph S2[1] is a subset of the corresponding factor nodes in another graph S2[2]. The condition nodes corresponding to all factor nodes belonging to the subset in the graph S2[1] are a subset of the condition nodes corresponding to another graph S2[2]. An absolute value of the difference of the probability respectively indicated by the conclusion nodes of the two graphs S2[1] and S2[2] is greater than 0.1 and less than 0.2, and the indicated probabilities are greater than 0.5 at the same time, or less than or equal to 0.5 at the same time.

A fourth scenario includes, if i=1, the factor nodes of the two graphs S2[1] and S2[2] are consistent. Assuming that the same condition factors are removed from the two graphs S2[1] and S2[2], the intersection of the remaining condition factors in the two graphs S2[1] and S2[2] is an empty set. The probabilities respectively indicated by the conclusion nodes of the two graphs S2[1] and S2[2] are greater than 0.5 at the same time, or less than or equal to 0.5 at the same time.

After completing the integration operation of the i-level graph S2[i] and the i+1-level graph S2[i+1] (if i=1, then they correspond to the first-level graph S2[1] and the second-level graph S2[2]), a new graph is generated while i is updated to i+1 at the same time. That is, after module S333 is executed, i is updated from 1 to 2.

In module S341, the processor 120 executes modules S313˜S324 according to the purchasing data of further next year (at this time, if i=2, then it corresponds to the third-level historical data D1[3]) to construct the i+1-level graph S2[i+1] (if i=2, then it corresponds to the third-level graph S2[3] of the third year). Similarly, the processor 120 may construct the multi-level graphs S2[1]˜S2[N] sequentially. In this embodiment, the operation of module S341 may refer to the operation of modules S313˜S324 and by analogy.

In module S342, the processor 120 executes the integration module 113 to enable the integration module 113 to integrate the new graph (e.g., the graph integrated by the first-level graph S2[1] and the second-level graph S2[2]) and the current i-level graph S2[i] (if i=2, then it corresponds to the third-level graph S2[3]) according to the rule to update this new graph. Similarly, in the operation of the last level N, the integration module 113 integrates the current new graph and the current N-level graph S2[N] according to the rule to update the new graph and utilizes the new graph as the output graph S3.

It should be noted that since the integration module 113 executes the integration operation on the current new graph sequentially year by year, the content of the graph may be continuously expanded to improve the predictive performance of the graph. In this embodiment, if i=1 represents the year 2011, the integration module 113 utilizes the rule to integrate the graph S2[1] of the year 2011 and the graph S2[2] of the next year (i.e., the year 2012) into a first graph. Then the rule is utilized to integrate the first graph and the graph S2[3] of the next year (i.e., 2013) into a second graph, and so on. The integration module 113 continuously integrates the current graph year by year until the graph S2[10] of all years (if N=10, then it corresponds to 10 years) has been integrated into the final output graph S3.

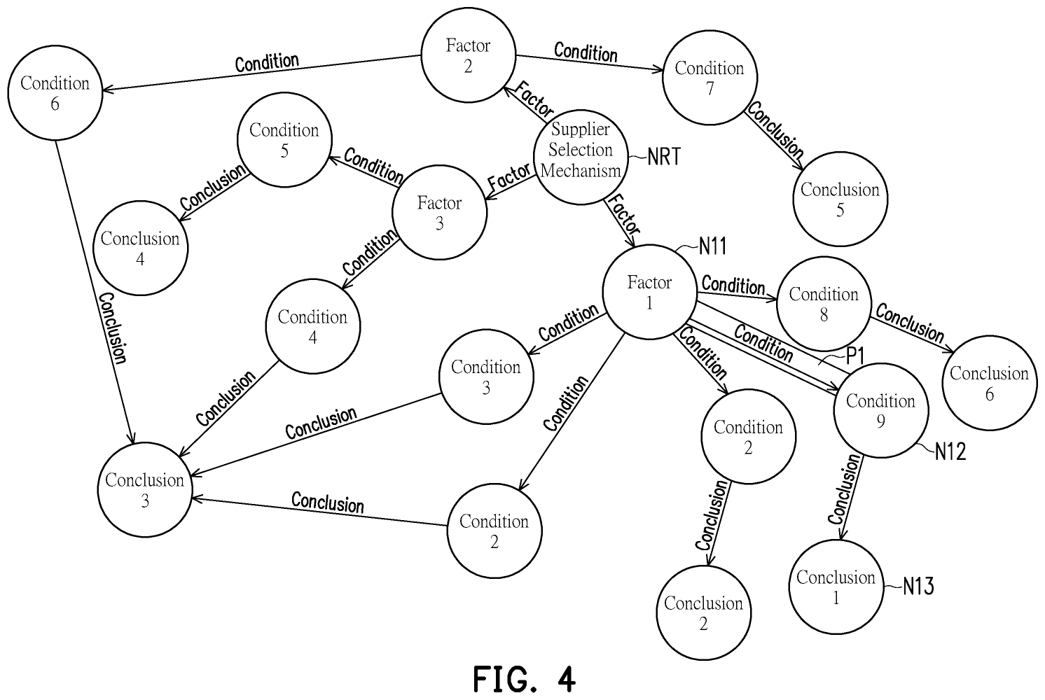

FIG. 4 is a schematic view of the output graph in the embodiment of FIG. 3 of the disclosure. Referring to FIG. 4, the output graph S3 may include a target node NRT, multiple factor nodes N11, multiple condition nodes N12, and multiple conclusion nodes N13. The target nodes NRT may be, for example, a supplier selection mechanism to predict the procurement status of a supplier through multiple nodes in the output graph S3.

In this embodiment, since the output graph S3 is a knowledge graph integrated from graphs S2[1]˜S2[N] corresponding to multiple years, the output graph S3 includes predicted routes and prediction results corresponding to these years. In this embodiment, the enterprise system 200 may execute the recommendation module to select triplet structure data corresponding to the latest year in the output graph S3 (e.g., nodes N11, N12, and N13) based on the output graph S3. The enterprise system 200 obtains a prediction result (i.e., conclusion node N13) according to a route P1 formed by the triplet structure data of the latest year.

To sum up, the knowledge graph construction system and the knowledge graph construction method of the disclosure construct knowledge graphs based on decision tree models and train the decision tree models by collecting multi-level historical data from the manufacturing industry. The knowledge graph construction system disassembles the trained decision tree models into triplet structure data and parses graphs of each year at all levels through entity alignment. The knowledge graph construction system continuously integrates the graph of the new year into the existing graph according to the rule in a year sliding manner, so that the graph automatically grows and optimizes, and the output graph is output accordingly. In this way, the enterprise system may implement prediction or recommendation result with high accuracy based on the output graph.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A knowledge graph construction system, comprising:
a storage device, storing a plurality of modules and accessing an enterprise system; and
a processor, coupled to the storage device and executing the modules, wherein the modules comprise a computing module, a classification and parsing module, and an integration module,
wherein the computing module respectively executes an index computation operation according to multi-level historical data in the enterprise system to generate multi-level index data,
wherein the classification and parsing module respectively executes a classification and parsing operation on the multi-level index data to generate a multi-level graph,
wherein the integration module sequentially integrates an i-level graph and a consecutive next-level graph in the multi-level graph according to a rule until graphs at all levels in the multi-level graph are integrated to generate an output graph, so that the enterprise system executes a prediction operation according to the output graph, and i is a positive integer.

2. The knowledge graph construction system according to claim 1, wherein the multi-level historical data comprises a plurality of work orders corresponding to a plurality of consecutive years.

3. The knowledge graph construction system according to claim 1, wherein the computing module extracts the multi-level historical data to obtain i-level historical data in the multi-level historical data, and the computing module calculates an association relationship between the i-level historical data to generate i-level index data in the multi-level index data.

4. The knowledge graph construction system according to claim 1, wherein a classification module in the classification and parsing module executes a preprocessing operation and a variance operation on i-level index data in the multi-level index data to generate an i-level sample data and construct an i-level decision tree model in a multi-level decision tree model.

5. The knowledge graph construction system according to claim 4, wherein the classification module trains the i-level decision tree model according to the i-level sample data.

6. The knowledge graph construction system according to claim 4, wherein a parsing module in the classification and parsing module converts the trained i-level decision tree model into triplet structure data to generate the i-level graph.

7. The knowledge graph construction system according to claim 1, wherein the i-level graph comprises triplet structure data, and the triplet structure data comprises a factor node, a condition node, and a conclusion node.

8. The knowledge graph construction system according to claim 1, wherein in response to a first node of the i-level graph and a second node of an i+1-level graph in the multi-level graph satisfying the rule, the integration module integrates the i-level graph and the i+1-level graph.

9. The knowledge graph construction system according to claim 1, wherein the rule comprises at least one of matching relationships between a plurality of factor nodes, a plurality of condition nodes, and a plurality of conclusion nodes and the i-level graph and the i+1-level graph, respectively.

10. The knowledge graph construction system according to claim 1, wherein the enterprise system selects triplet structure data corresponding to a latest year in the output graph to obtain a prediction result according to a route formed by the triplet structure data of the latest year.

11. A knowledge graph construction method, comprising:
storing a plurality of modules and accessing an enterprise system through a storage device; and
executing the modules through a processor, wherein the modules comprise a computing module, a classification and parsing module, and an integration module, comprising:
respectively executing an index computation operation through the computing module according to multi-level historical data in the enterprise system to generate multi-level index data;
respectively executing a classification and parsing operation on the multi-level index data through the classification and parsing module to generate a multi-level graph; and
sequentially integrating an i-level graph and a consecutive next-level graph in the multi-level graph through the integration module according to a rule until graphs at all levels in the multi-level graph are integrated to generate an output graph, so that the enterprise system executes a prediction operation according to the output graph, wherein i is a positive integer.

12. The knowledge graph construction method according to claim 11, wherein the multi-level historical data comprises a plurality of work orders corresponding to a plurality of consecutive years.

13. The knowledge graph construction method according to claim 11, wherein respectively executing the index computation operation according to the multi-level historical data in the enterprise system to generate the multi-level index data comprises:
extracting the multi-level historical data through the computing module to obtain i-level historical data in the multi-level historical data; and
calculating an association relationship between the i-level historical data through the computing module to generate i-level index data in the multi-level index data.

14. The knowledge graph construction method according to claim 11, wherein respectively executing the classification and parsing operation on the multi-level index data to generate the multi-level graph comprises:
executing a preprocessing operation and a variance operation on i-level index data in the multi-level index data through a classification module in the classification and parsing module to generate an i-level sample data; and
constructing an i-level decision tree model in a multi-level decision tree model through the classification module.

15. The knowledge graph construction method according to claim 14, wherein respectively executing the classification and parsing operation on the multi-level index data to generate the multi-level graph comprises:
training the i-level decision tree model through the classification module according to the i-level sample data.

16. The knowledge graph construction method according to claim 14, wherein respectively executing the classification and parsing operation on the multi-level index data to generate the multi-level graph comprises:
converting the trained i-level decision tree model into triplet structure data through a parsing module in the classification and parsing module to generate the i-level graph.

17. The knowledge graph construction method according to claim 11, wherein the i-level graph comprises triplet structure data, and the triplet structure data comprises a factor node, a condition node, and a conclusion node.

18. The knowledge graph construction method according to claim 11, wherein sequentially integrating an i-level graph and a consecutive next-level graph in the multi-level graph according to the rule until graphs at all levels in the multi-level graph are integrated to generate an output graph comprises:
integrating the i-level graph and an i+1-level graph through the integration module in response to a first node of the i-level graph and a second node of the i+1-level graph in the multi-level graph satisfying the rule.

19. The knowledge graph construction method according to claim 11, wherein the rule comprises at least one of matching relationships between a plurality of factor nodes, a plurality of condition nodes, and a plurality of conclusion nodes and the i-level graph and the i+1-level graph, respectively.

20. The knowledge graph construction method according to claim 11, further comprising:
selecting triplet structure data corresponding to a latest year in the output graph through the enterprise system to obtain a prediction result according to a route formed by the triplet structure data of the latest year.
